(19) United States
(12) Patent Application Publication
(10) Pub. No.: US 2006/0018197 A1
(43) Pub. Date: Jan. 26, 2006

(54) Acoustic biomass monitor

(75) Inventors: Janusz Burczynski, Seattle, WA (US); Assad Ebrahim, Bellevue, WA (US); John Hedgepeth, San Luis Obispo, CA (US)

Correspondence Address: MILLER NASH LLP, 4400 TWO UNION SQUARE, 601 UNION STREET, SEATTLE, WA, 98101-2352, US

(73) Assignee: BioSonics, Inc.

(21) Appl. No.: 10/894,887

(22) Filed: Jul. 20, 2004

(51) Int. Cl. G01S 15/96

(52) U.S. Cl. 367/87

(57) ABSTRACT

The present invention relates to the field of monitoring systems, and specifically, to monitoring systems for measuring fish size, fish quantity and total fish biomass in a fish farming operation. The fish are located in a seacage in a body of water. A mobile platform is placed on the surface water above the seacage and is moved in a transect pattern above the seacage. A transducer with associated transceiver attached to the mobile platform generates an echo pattern that is converted by a processor into estimates relating to fish size, fish quantity, and total fish biomass data of the fish located in the seacage.

### BACKGROUND OF INVENTION

1. Field of Invention

The present invention relates to the field of monitoring systems, and specifically, to monitoring systems for measuring fish size, fish quantity and total fish biomass in a fish farming operation.

2. Description of the Related Art

Frequent estimates of fish size, fish quantity, and total fish biomass are essential to the daily decisions made in fish farming operations. The accuracy of these estimates, and the decisions resulting from these estimates, significantly impact the profitability of fish farming operations.

Most fish farms use floating “seacages” to hold the fish raised on the fish farm. The seacages are usually made of a mesh material, preferably net or webbing. The mesh material is customarily sized to prevent fish from escaping the seacage, while simultaneously providing for the free circulation of water through the seacage. It is preferred that the seacage completely encapsulate the fish with the exception of the surface water area.

Somewhat analogous to raising livestock, profitability and risk management at a fish farming operation are directly related to the size, quantity and biomass of living fish present in a seacage. Thus, fish farming operations seek to maximize the rate at which fish located in seacages grow, while minimizing the loss of fish due to disease, marine mammal predation, fish escapement and theft. Accurate estimates of fish size, fish quantity, and total fish biomass in a seacage are therefore critical to determine feeding schedules, amount of food given, the dosage of medicine, early detection of fish escape or loss, prediction of food conversion rates, and inventory-based insurance rates.

Customarily, to determine fish-related estimates, including estimates as to the size, quantity and biomass of living fish present in a seacage, fish farming operations use labor intensive human handling methods. However, unlike some animals, live fish get extremely stressed when handled by humans. Human handling of fish often results in a reduction of a fish's appetite, growth rate and immunological response, and in turn, increases the fish's susceptibility to disease, and ultimately, death.

Human handling methods are in direct opposition to the profitability of fish farming efforts. As a result, despite the critical need for timely and accurate information regarding fish size, quantity and total biomass, fish farms limit human handling methods to, typically, only once a month, and not at all during the final three months before a harvest. This results in a fish farm being unable to assess fish stock on a daily basis, thereby resulting in a fish farm's inability to obtain information necessary to better control and manage feeding operations, fish production rates, and overall efficiency and profitability of the fish farm.

### BRIEF SUMMARY OF THE INVENTION

The present invention relates to the field of monitoring systems, and specifically, to monitoring systems for measuring fish size, fish quantity and total fish biomass in a fish farming operation.

In an exemplary embodiment of the present invention, the aquaculture biomass monitor system is used to estimate fish size, fish density and fish biomass for a plurality of fish located in a seacage. The system, which includes an acoustic transducer with associated transceiver positioned within the seacage, is capable of generating both at least one acoustic signal and a plurality of sensor measurements associated with the plurality of fish located in the seacage. The system further includes a processor connected to the transceiver. The processor is capable of converting a plurality of acoustic echo signals from the transducer and a plurality of sensor measurements into screen displays and reports. Preferably, the acoustic transducer, transceiver and processor are located on a mobile platform capable of traversing above the seacage. In an alternate embodiment, the processor is remotely connected to the transceiver and remotely receives data from the transceiver.

The system further includes an instrument control interface by which an aquaculture biomass monitor system can be controlled. Preferably, the instrument control interface provides system control parameters including acoustic parameters, transect patterns, rates of travel, and editable data fields.

A method of estimating fish size, fish density and fish biomass in a seacage is also disclosed. The method preferably includes locating a plurality of fish in a seacage, locating a mobile platform on the surface water of a seacage, generating at least one acoustic signal and receiving a plurality of acoustic echo signals using an acoustic transducer with associated transceiver, acquiring a plurality of sensor measurements from a plurality of sensors, and converting the plurality of acoustic echo signals and plurality of sensor measurements into screen displays and reports using a processor connected to the transceiver.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a pictorial view of an aquaculture biomass monitor constructed in accordance with the present invention.

FIG. 2 is a schematic functional diagram illustrating the major hardware and software components of the present invention.

FIG. 3 is a pictorial view of an exemplary embodiment of the mobile platform of the acoustic biomass monitor system constructed in accordance with the present invention.

### DETAILED DESCRIPTION OF THE INVENTION

The present invention relates to the field of monitoring systems, and specifically, to monitoring systems for measuring fish size, fish quantity and total fish biomass in a fish farming operation. The present invention provides a way to measure fish size, quantity and total biomass in a seacage with greater accuracy, lower labor requirements, and without human handling of live fish. This allows fish stock assessment to be done more frequently and at lower cost, thereby providing fish farming operations with the information necessary to better control and manage feeding operations, increase fish production rates, improve efficiency and increase profitability.

As used herein, “fish” means any aquatic animal, and it should be understood that the present invention is not limited to specific types of fish. In fact, the present invention is suitable for use in any “environment” where fish or other aquatic animals are farmed or maintained, including but not limited to oceans, seas, lakes, rivers, man-made environments or riverbed aquaculture farms. Further, the term “seacage” is used throughout this detailed description and should be understood to mean any device or method used to contain an aquatic animal.

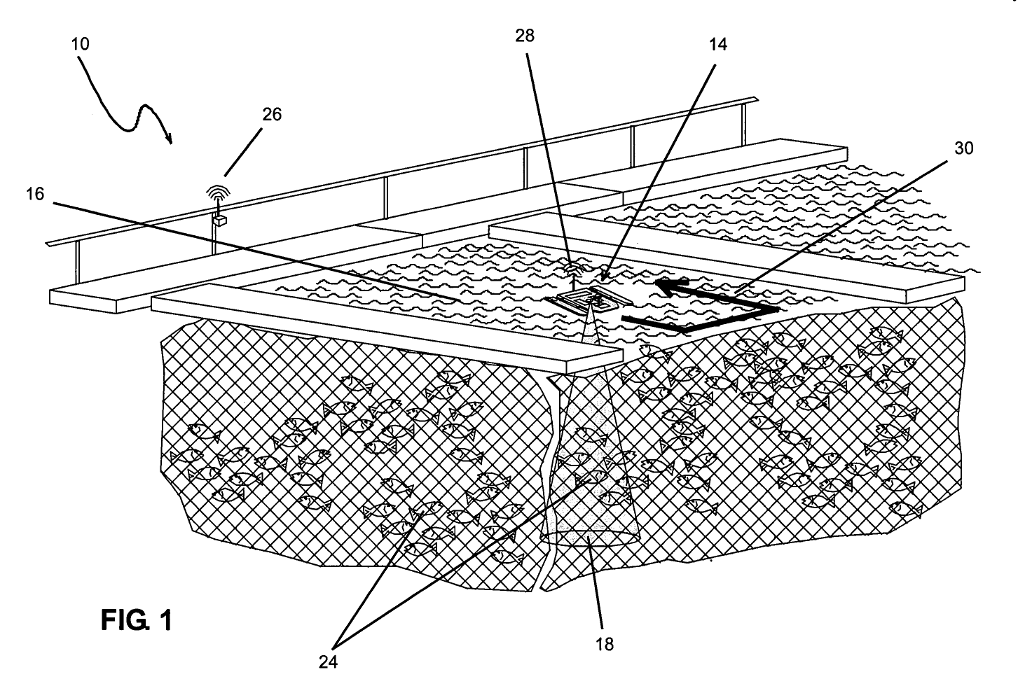

Referring now to the drawings, and first to FIG. 1, shown generally at 10 is an aquaculture biomass monitor system (hereinafter referred to as “system”) constructed in accordance with a preferred embodiment of the invention. Fish, indicated schematically at 24, generally swim freely throughout a seacage 16.

The system 10 includes an acoustic transducer 12 with associated transceiver 58, preferably positioned within a seacage and located on a mobile platform 14. In a first preferred embodiment, the mobile platform 14 is located on the surface water of a seacage 16, thereby allowing for the taking of fish-related estimates throughout any part, or all, of the seacage 16. In a second preferred embodiment, the mobile platform 14 is capable of being submerged and located below a seacage, at the side of a seacage, or within a seacage. For purposes of this detailed description, all references to a mobile platform 14 will be in the context of a mobile platform 14 located on the surface water of a seacage 16.

In use, the mobile platform 14 moves along the surface water of a seacage 16, preferably in accordance with navigation data 42 specifying a transect pattern 30 to be followed. An exemplary transect pattern is indicated schematically at 30. As indicated schematically by reference numerals 26 and 28 in FIG. 1, the movement of the mobile platform 14 is controlled by remote control equipment, although it should be appreciated that the mobile platform 14 may be remotely controlled using a wireless guidance system (not shown).

The mobile platform 14 may obtained from different sources with the above performance specifications. However, a suitable mobile platform 14 that will perform in accordance with this detailed description is the prototype remotely guided surface craft sold by Appliance Computing, Seattle, Wash. 98107 USA. The Appliance Computing surface craft is capable of being steered remotely at a variety of speeds and autonomously following a transect pattern consisting of differential GPS (“DGPS”) waypoints.

The exemplary equipment used to control the movement of the mobile platform 14 may be remote control equipment 26 and 28, which may be obtained from different sources with the above performance specifications. The mode of connection is preferably conventional and would be well understood by anyone skilled in the art after having acquired the acoustic transducer 12 with associated transceiver 58, the mobile platform 14, and remote control equipment 26 and 28. Suitable remote control equipment that will perform in accordance with this detailed description is the WET11 Wireless Ethernet Bridge sold by LinkSys, 17401 Armstrong Ave, Irvine, Calif. 92614, USA.

It is preferred that the mobile platform 14 include sensors such as an optional temperature sensing device (not shown), position sensing device 20 and an optional orientation sensing device 22 (collectively, “sensors”). The temperature sensing device monitors the temperature of the water in the seacage and is commonly known in the industry. The purpose of the positioning sensing device 20 is to determine the position of the mobile platform 14 in relation to the seacage 16. The positioning sensing device may be a DGPS receiver. The optional orientation sensing device 22 measures the aim of the acoustic beam 18 into the seacage 16. The optional orientation sensing device 22 may be a heading-pitch-roll sensor. Equipping the system 10 with the position sensing device 20 and the optional orientation sensing device 22 enables the association of each estimate taken by the system 10 with specific locations within the seacage 16.

The position sensing device 20 may be obtained from different sources with the above minimum performance specifications. A suitable position sensing device that will perform in accordance with this detailed description is the Differential GPS 212W sold by JRC, 1011 SW Klickitat Way, Bldg. B, Suite 100, Seattle, Wash. 98134, USA. The orientation sensing device 22 may be obtained from different sources with the above performance specifications. A suitable orientation sensing device that will perform in accordance with this detailed description is the Gyro-Enhanced Inclinometer sold by MicroStrain, Inc., 3 10 Hurricane Lane, Suite 4, Williston, Vt. 05495, USA.

As stated previously, the acoustic transducer 12 with associated transceiver 58 is preferably located on the mobile platform 14. The acoustic transducer 12 is operated to emit at least one acoustic signal into the seacage 16. While it is preferable to keep the acoustic transducer 12 as vertically aimed as possible, the position of the acoustic transducer 12 may be influenced by the effect of current and weather conditions, and by the speed with which the mobile platform 14 is driven along its transect pattern 30. If the optional orientation sensing device 22 is used, it may measure the aim of the acoustic beam 18 into the seacage 16, thereby allowing measured deviations in acoustic transducer 12 aim to be corrected by algorithms in the processor 32. The acoustic transducer 12 may additionally be rigged in a cardanic suspension or similar device to keep the acoustic transducer 12 in a stable vertical position, regardless of changes in current, weather or mobile platform movement. This type of suspension technique is well-known in the industry.

The acoustic transducer 12 with associated transceiver 58 may be obtained from different sources with the above performance specifications. However, a suitable transducer 12 with associated transceiver 58 that will perform in accordance with this detailed description is the DE-X model single-beam transducer with associated transceiver sold by BioSonics, Inc., 4027 Leary Way NW, Seattle, Wash. 98107 USA. The BioSonics transducer with associated transceiver is capable of emitting at least one acoustic signal with a variety of pulse characteristics. Various transducers can be manufactured for various beam angles and various frequencies.

Preferably, in use, the acoustic transducer 12 with associated transceiver 58 is located on the mobile platform 14 and does not require attendance. Instead, the acoustic transducer 12 with associated transceiver 58 transmits at least one acoustic signal throughout the seacage 16 and receives returning acoustic echo signals, which are processed in order to estimate such fish-related measurements as fish size of individual fish, map fish density within the seacage, and estimated fish biomass.

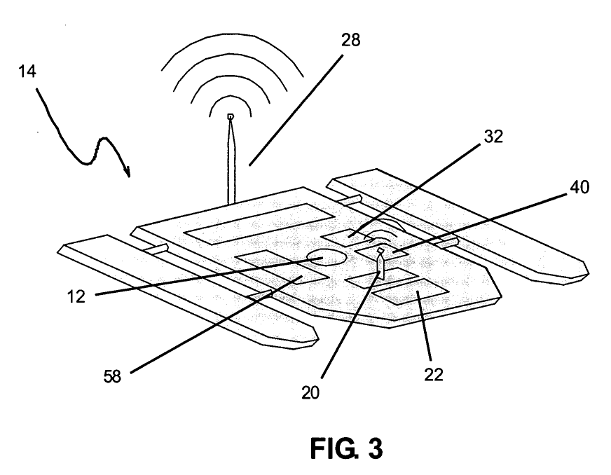

As shown in FIG. 3, the transceiver 58 is connected to a processor 32. It should be appreciated that the “processor” 32 may be a single-board computer, embedded processor, laptop, palm top, personal computer or any other conventional or specialized computer processor. It should be further appreciated that connected means physically or remotely connected.

In a first embodiment, the processor 32 is located on the mobile platform 14. In a second embodiment, the processor 32 resides separately from the mobile platform 14 and is remotely connected to the transceiver 58. The mode of connecting the transceiver 58 to the processor 32 is conventional and would be well understood by anyone skilled in the art after having acquired the type of acoustic transducer 12 with associated transceiver 58 as described above. However, in one preferred embodiment, it is preferred that the data delivered from the transceiver 58 to the processor 32 be via conventional TCP/IP and UDP/IP protocols.

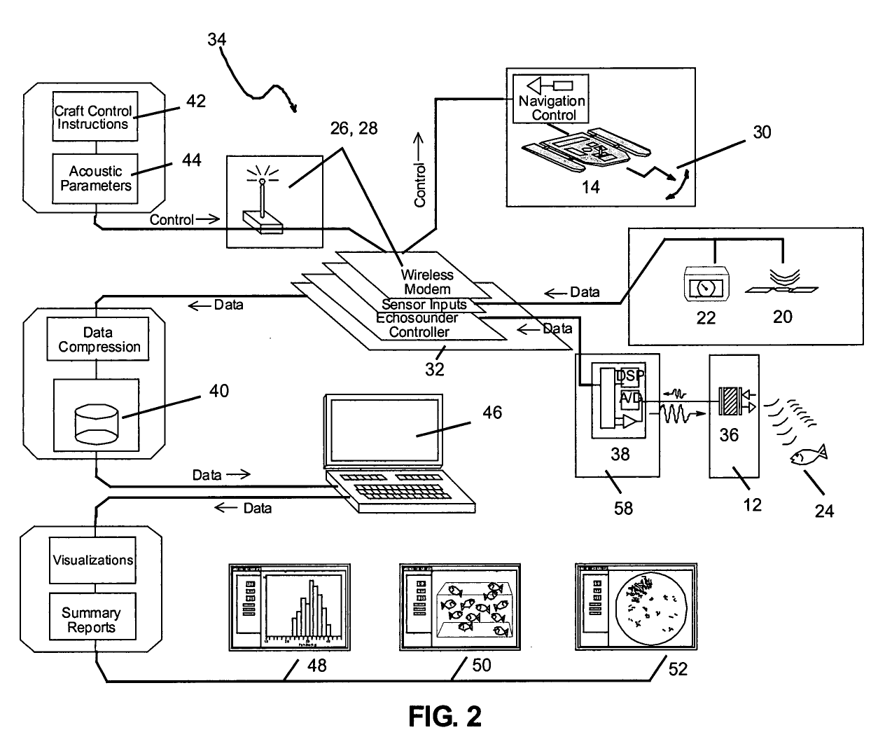

Referring now to FIG. 2, the acoustic transducer 12 with associated transceiver 58 is shown schematically to include the transducing element 36 and transceiver electronics 38. The acoustic transducer 12 with associated transceiver 58 generates at least one acoustic signal to ensonify a volume within the seacage, and receives a plurality of acoustic echo signals. Data from the acoustic transducer 12 with associated transceiver 58 and sensors is collected by the processor 32. Data can be written to a conventional or specialized data storage device 40 associated with the processor 32.

The system 10 includes an instrument control interface by which a system 10 can be controlled. Preferably, the instrument control interface provides system control parameters including acoustic parameters, transect patterns, rates of travel, and editable data fields. For example, the system 10 may be used to take measurements in a plurality of seacages 16. When the system 10 is used with a plurality of seacages 16, it is desirable to allow a system operator to use the instrument control interface to input data specific to each seacage 16, which may include items of information like navigation data 42 specifying a transect pattern 30 to be followed, and acoustic parameters 44 to be used. The means for submitting this data to the mobile platform 14 may be either hardware (buttons, knobs, mouse, keyboard) and/or software (user interface with edit fields and configuration files).

As the mobile platform 14 traverses above the seacage 16, following the specified navigation data 42, the acoustic data and sensor measurements taken are processed by processing software 46 to produce visualizations and reports of such estimates as fish size distribution 48, fish biomass 50, and fish density 52. Visualizations of fish size distribution 48, fish biomass 50 and fish density 52 present the information such as the distribution and mean value of fish size, an estimate of total fish biomass in a seacage 16, and a three-dimensional map of fish density in a seacage 16.

The means for processing the signals from the acoustic transducer 12 with associated transceiver 58, optional orientation sensing device 22, optional temperature sensing device, and position sensing device 20 to obtain the information described above are a function of software programming. The software can be written in any programming language (e.g. the C programming language), and/or may be implemented in software or hardware. The processing software, shown pictorially at 46, can be written to operate in real-time on streaming acoustic data and sensor measurements or on data that has already been collected and written to a data storage device 40.

The processing software 46 preferably includes an algorithm for calibrating the attenuation of sound against fish species and fish size. The attenuation of sound may be measured by either echo level or echo intensity techniques.

The processing software 46 further preferably includes an algorithm for measuring individual fish size based on measured target strength. The target strength is preferably measured by the EMS algorithm which uses backscattering cross section σ_{bs}, of individual fish, or other target strength estimation methodology. This allows fish size to be estimated using fish target strength vs. length relationship.

The processing software 46 may also include an algorithm for measuring fish biomass based on measurements of fish density and density distribution in the seacage 16. Fish density is customarily measured using the Single Scattering with Attenuation (“SSA”) echo integration algorithm or other echo integration methodology-techniques. The algorithm requires an estimate of extinction cross section of fish which is measured from attenuation of sound wave by fish aggregation:

$${σ}_{e} = \frac{{α}_{f}}{4.34 ρ}$$

where
σₑ [m²] is extinction cross section of fish
α_{f} [dB/m] is sound attenuation by fish, which is estimated by the calibration algorithm described above and using, for example, the relationships of backscattered intensity I and attentuation of water α_{W} [dB/m] from range r:

$${I}_{r , no fish} = {k ( \frac{{e}^{- {α}_{f} r}}{{r}^{2}} )}^{2} and {I}_{r , fish} = {k ( \frac{{e}^{- {α}_{w} r} {e}^{- {α}_{f} r}}{{r}^{2}} )}^{2}$$
ρ[fish number/m³] is fish density, which can be estimated using Foote's equation:

$$ρ = \frac{ln ( 1 - \frac{2 {σ}_{e} {s}_{v} ( {z}_{2} - {z}_{1} )}{{σ}_{bs}} )}{- 2 {σ}_{e} ( {z}_{2} - {z}_{1} )}$$

Furosawa's quadratic regression equation provides another necessary parameter:
σ_{eW}=5.34×10⁻³+2.16×10⁻⁵f+3.15×10⁻⁸f²
where
f is frequency in kHz and σ_{eW} is in m²/kg^{2/3}.

Therefore, total fish biomass can be estimated by volume integrating the fish densities computed above over the seacage 16.

Data from the acoustic transducer 12 with associated transceiver 58 and sensors will be recorded and include a record of echoes with range, bearing and time. A record of nulls (or omissions without echoes) may also be made.

Another algorithm may be used to record the background noise against which fish 24 can be detected. By incorporating the calibration data, any noise from other structures such as the seacage 16 or cables can be recognized and eliminated to create data structures that indicate only the size and density of fish 24 from the seacage 16.

Acoustic scattering models are required in order to implement the algorithms. Acoustic scattering is a function of fish species, fish size, aspect to the acoustic beam, and aggregation density. Transducer calibration in a seacage without fish and using a standard target is preferably also done in order to develop a baseline echo response required for the density and biomass estimation algorithms.

The terms and expressions used in the foregoing specification are used as terms of description and not of limitation, and are not intended to exclude equivalents of the features shown and described or portions of them. The scope of the invention is defined and limited only by the claims that follow.

1. An aquaculture biomass monitor system for use in estimating the size, density and biomass of a plurality of aquatic animals in a seacage, said system comprising:
(a) an acoustic transducer with associated transceiver, said acoustic transducer with associated transceiver capable of generating at least one acoustic signal within said seacage and receiving a plurality of acoustic echo signals from within said seacage, each of said acoustic echo signals received corresponding to an aquatic animal;
(b) a plurality of sensors, said plurality of sensors capable of receiving a plurality of sensor measurements;
(c) a mobile platform, said acoustic transducer with associated transceiver and said plurality of sensors located on said mobile platform; and
(d) a processor, said processor connected to said transceiver and capable of converting said plurality of acoustic echo signals and said plurality of sensor measurements into screen displays and reports.

2. The system of claim 1, said plurality of sensors chosen from a group consisting of:
(a) a temperature sensing device;
(b) a position sensing device; and
(c) an orientation sensing device.

3. The system of claim 1, said mobile platform capable of traversing a transect pattern.

4. An instrument control interface by which an aquaculture biomass monitor system can be controlled; wherein said instrument control interface provides system control parameters chosen from a group consisting of:
(a) a plurality of acoustic parameters;
(b) at least one transect pattern;
(c) at least one rate of travel; and
(d) at least one editable data field.

5. A method of estimating size, density and biomass of a plurality of aquatic animals in a seacage, said method comprising:
(a) locating a mobile platform on surface water of a seacage, said mobile platform including an acoustic transducer with associated transceiver, a plurality of sensors and a processor connected to said transceiver;
(b) generating at least one acoustic signal from said acoustic transducer with associated transceiver;
(c) receiving a plurality of acoustic echo signals and a plurality of sensor measurements; and
(d) converting said plurality of acoustic echo signals and said plurality of sensor measurements into screen displays and reports using said processor.

6. The system of claim 1, said system being controlled by an instrument control interface, said instrument control interface providing system control parameters chosen from a group consisting of:
(a) a plurality of acoustic parameters;
(b) at least one transect pattern;
(c) at least one rate of travel; and
(d) at least one editable data field.
